(19) United States
(12) Patent Application Publication
(10) Pub. No.: US 2006/0154524 A1
(43) Pub. Date: Jul. 13, 2006

(54) Shell for electrical connector

(75) Inventors: Shang-Yen Huang, Taipei (TW); Sheng-Ho Yang, Taipei (TW)

Correspondence Address: BRUCE H. TROXELL, SUITE 1404, 5205 LEESBURG PIKE, FALLS CHURCH, VA, 22041, US

(73) Assignee: Advanced Connectek Inc.

(21) Appl. No.: 11/138,364

(22) Filed: May 27, 2005

(30) Foreign Application Priority Data
Jan. 7, 2005 (TW) 094200395

(51) Int. Cl. H01R 13/648

(52) U.S. Cl. 439/607

(57) ABSTRACT

Provided is a parallelepiped electrical connector shell with a terminal seat enclosed therein. The shell is mountable on a PCB and is adapted to connect to a port of a mating connector. The shell comprises a first latch on a top surface for engaging with a recess on a mating connector shell, two second latches on a top surface for clamping the mating connector, and a punched out stop mechanism inwardly extended from the shell. A distance from the stop mechanism to the port is a predetermined insertion depth of the mating connector. The invention can limit the insertion depth. Also, it can prevent a housing from displacing due to an excessive insertion force exerted by the mating connector.

### BACKGROUND OF THE INVENTION

1. Field of Invention

The present invention relates to electrical connectors and more particularly to an electrical connector shell having stop members for preventing the housing from being pushed out of its proper position by a mating connector in a plugging or unplugging operation.

2. Description of Related Art

It can say that digitization is the most important advancement in modern technology as compared to conventional computer peripheral devices such as printer, scanner, etc. Digital cameras, digital video cameras, and digital music players also become computer peripheral devices. In the digitization, ports and electrical connectors play an indispensable role in connecting peripheral devices to computers. Standards about ports are defined in IEEE1394, USB, or the like. Such ports have the functionalities of supplying power, plug-and-play, hot-plug, etc. They also can connect to more than 60 devices. For example, USB can connect 127 devices theoretically. Of course, the essential requirement is the transmission speed. The highest theoretical transmission speed of USB2.0 is as high as 480 Mbps. The highest theoretical transmission speed of IEEE1394 is also up to 400 Mbps. In the future the transmission speed of USB or IEEE1394 can be faster. Therefore, some peripheral devices, such as CD-ROM drives, hard disk drives, etc., installed in the computer in the past can also be installed externally of the computer for increasing data transmission speed. But it must connect to different devices by means of wires in order to achieve the foregoing objects.

Advanced transmission interfaces have functions or features of plug-and-play, hot-plug, etc. This is a contrast to prior transmission interfaces which only require an electrical connector to plug for first time use or unplug for replacement. Now, it has advanced that an electrical connector can be plugged or unplugged at any time. This means that it is not required to use a fastener (e.g., screw, etc.) to fasten male and female connectors having the transmission interface together.

An electrical connector having latches on its shell is disclosed in U.S. Pat. No. 6,554,648 as shown in FIG. 1. The shell A of the connector on its either front or rear surface comprises a pair of first latches B and a second latch C between the first latches B. The first latches B are adapted to engage with recesses of a connected mating connector. Also, an elastic fastening force exerted on the mating connector by the second latches C is able to enhance the engagement so as to obtain a stable locking fastening of the connected connectors.

But the prior fastening is not reliable. It is possible of inserting the connector excessively to push a housing of the connector backward if sufficient care is not taken. As a result, the housing is pushed out of its proper position. Also, problems such as component displacement, poor electrical contact, and insufficient fastening force between the housing and the shell of the mating connector occur. To the worse, a peripheral device mounted with the connector may fall on the ground if sufficient care is not taken in plugging or unplugging the connector. Thus, the need for improvement still exists.

### SUMMARY OF THE INVENTION

It is therefore an object of the present invention to provide an electrical connector shell having stop members with a housing and terminals enclosed so as to form the electrical connector. By utilizing the electrical connector shell, it is possible of preventing the housing from displacing due to an excessive insertion force exerted by the mating connector.

To achieve the above and other objects, the present invention provides an electrical connector shell of being substantially parallelepiped including a top surface, a bottom surface, and two sidewalls with a terminal seat enclosed therein, the electrical connector shell being mountable on a PCB and being adapted to connect to a port of a mating connector for electrical connection, comprising a first latch on the top surface, the first latch being adapted to engage with a recess on a shell of the mating connector; two second latches on the top surface; the second latches being adapted to clamp the mating connector; and a stop mechanism; wherein a distance from the stop mechanism to the port is a predetermined insertion depth of the mating connector.

The above and other objects, features and advantages of the present invention will become apparent from the following detailed description taken with the accompanying drawings.

### BRIEF DESCRIPTION OF THE DRAWINGS

FIG. 1 is a perspective view of the shell of a conventional electrical connector;

FIG. 2 is a perspective view of a first preferred embodiment of electrical connector according to the present invention;

FIG. 3 is a perspective view of a second preferred embodiment of electrical connector according to the present invention;

FIG. 4 is a perspective view of a third preferred embodiment of electrical connector according to the present invention;

FIG. 5 is a perspective view of a fourth preferred embodiment of electrical connector according to the present invention; and

FIG. 6 is a perspective view of a fifth preferred embodiment of electrical connector according to the present invention.

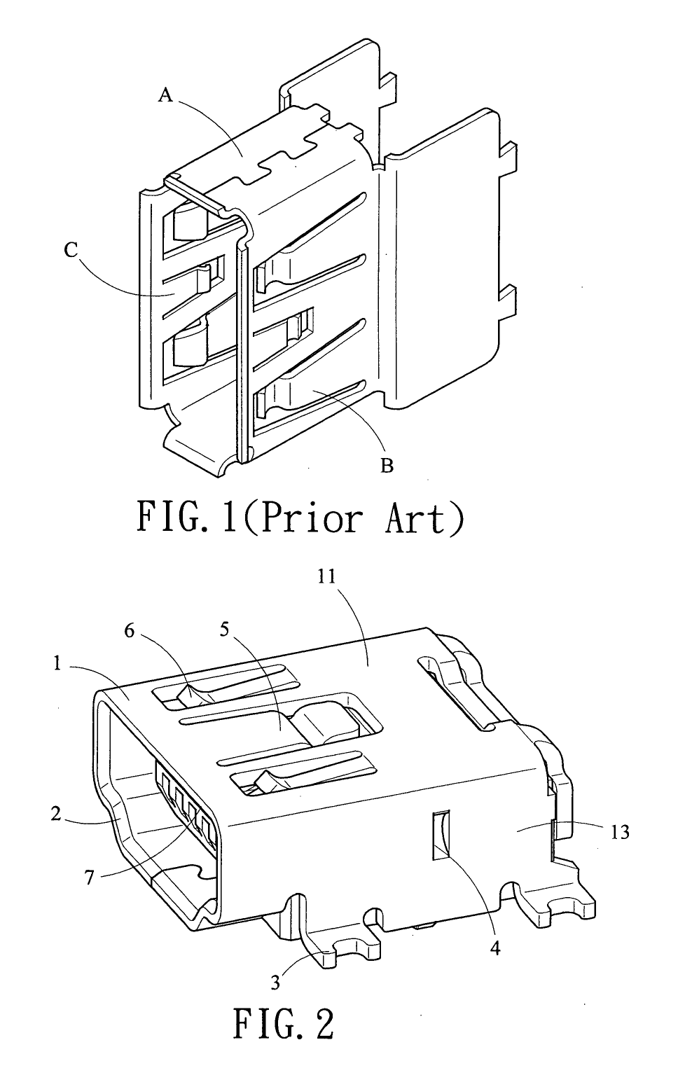

### DETAILED DESCRIPTION OF THE INVENTION

Referring to FIG. 2, which is a perspective view of a first preferred embodiment of electrical connector according to the invention. A shell 1 encloses a terminal seat 7 formed by a housing and terminals. An electrical connector is comprised of the shell 1 and the terminal seat 7. The electrical connector comprises a mating port 2 for permitting a mating connector to connect thereto for electrical connection. In the first embodiment, the electrical connector is adapted to mounted on a printed circuit board (PCB) as an input/output port for connecting to a mating connector. The shell 1 comprises a first latch 5 and two second latches 6 on its top surface. The first latch 5 is adapted to engage with a recess on a shell of the mating connector and the second latches 6 are adapted to clamp the mating connector. The shell 1 comprises a stop member 4 on an appropriate position of an inner side of either sidewall 13 thereof. The stop member 4 is a concave member on the shell 1. A distance from the stop member 4 to the mating port 2 is the insertion depth of the corresponding mating connector so as to limit the connector insertion depth. Moreover, the shell 1 is provided with a plurality of solder legs 3 adapted to fasten the connector on the PCB by means of surface mounting (SMT).

The provision of the stop member 4 is to control the depth of inserting the mating connector in the electrical connector for avoiding the housing from being displaced if the insertion force of the mating connector is excessive. The provision of the stop member 4 also can provide a reliable fastening between the mating connector and the connector. Therefore, the stop member 4 can be disposed on any position on the inner sidewall of the shell 1.

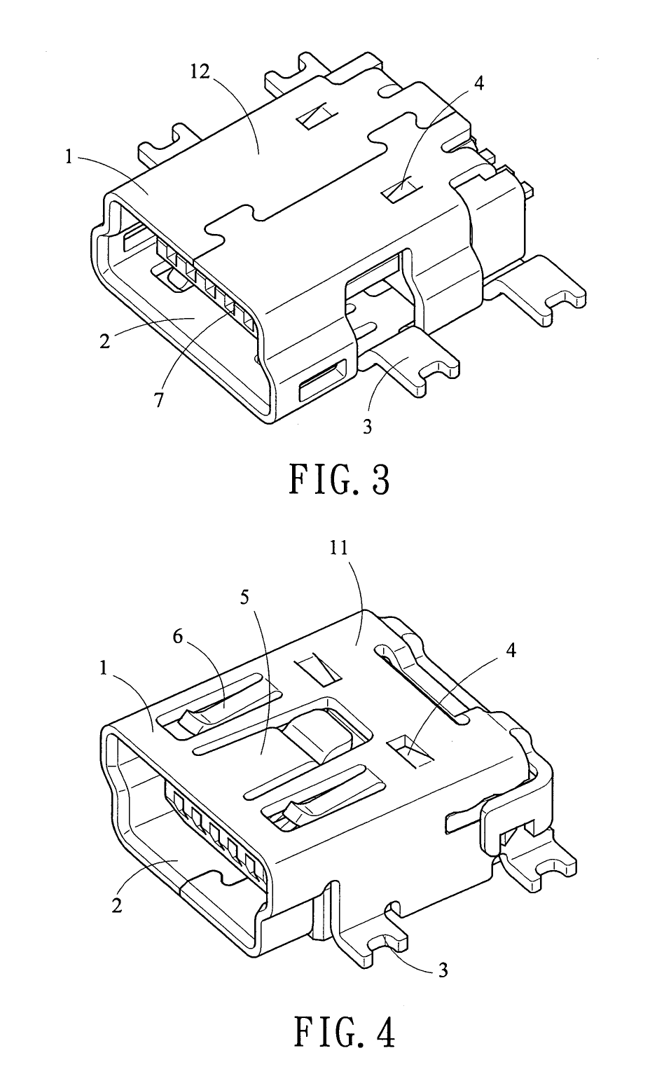

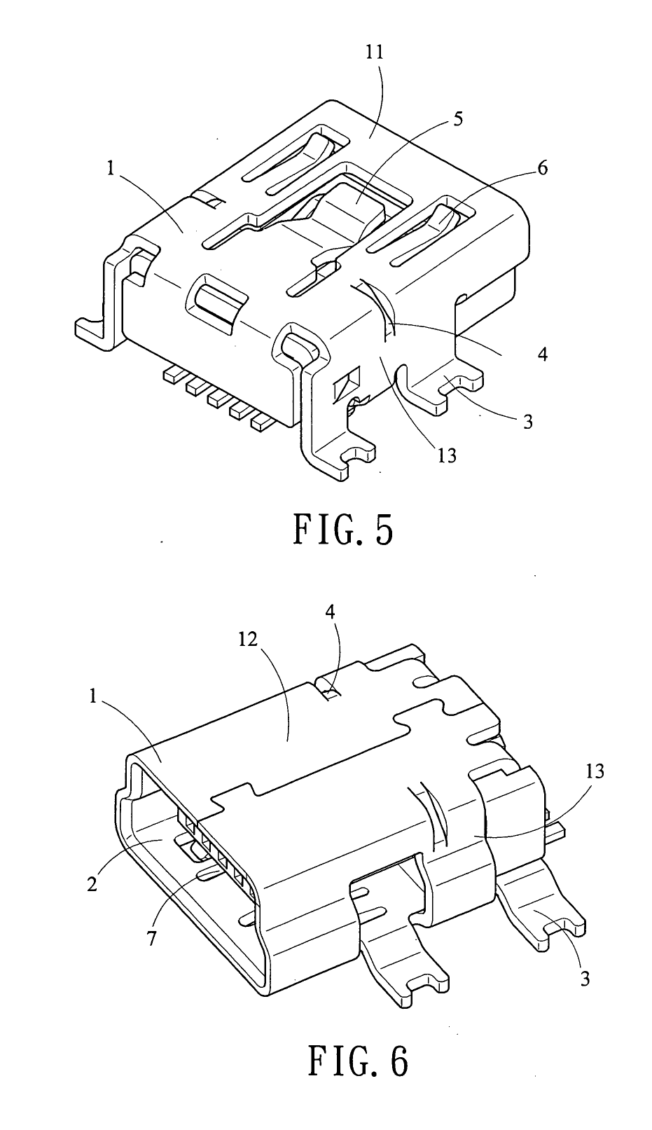

As shown in a second preferred embodiment of FIG. 3, the stop members 4 are disposed on a bottom surface 12 of the shell 1 and are proximate both sides thereof. As shown in a third preferred embodiment of FIG. 4, the stop members 4 are disposed on a top surface 11 of the shell 1 and are proximate both sides thereof. As shown in a fourth preferred embodiment of FIG. 5 and a fifth preferred embodiment of FIG. 6, either stop member 4 is disposed on either a joining portion of the sidewall 13 and the top surface 11 or a joining portion of the sidewall 13 and the bottom surface 12 respectively. Alternatively, the stop members 4 are disposed on the top surface 11 and both sidewalls 13, the bottom surface 12 and both sidewalls 13, or the top surface 11, the bottom surface 12, and both sidewalls 13 in other embodiments.

In the foregoing embodiments, the shell 1 is a metal plate and is comprised of a first latch 5, second latches 6, and solder legs 3 all formed by stamping. The stop members 4 can also be formed by stamping. In the manufacturing process, a blank is stamped by a punch and then is bent to form a shell 1. The shell 1 is finally assembled with the terminal seat 7 to form an electrical connector of the invention.

While the invention herein disclosed has been described by means of specific embodiments, numerous modifications and variations could be made thereto by those skilled in the art without departing from the scope and spirit of the invention set forth in the claims.

What is claimed is:

1. An electrical connector shell of being substantially parallelepiped including a top surface, a bottom surface, and two sidewalls with a terminal seat enclosed therein, the electrical connector shell being mountable on a PCB and being adapted to connect to a port of a mating connector for electrical connection, comprising:
a first latch on the top surface, the first latch being adapted to engage with a recess on a shell of the mating connector;
two second latches on the top surface, the second latches being adapted to clamp the mating connector; and
a stop mechanism;
wherein a distance from the stop mechanism to the port is a predetermined insertion depth of the mating connector.

2. The electrical connector shell as claimed in claim 1, wherein the stop mechanism is inwardly extended from the shell.

3. The electrical connector shell as claimed in claim 1, wherein the stop mechanism comprises two spaced stop members disposed on the top surface of the shell.

4. The electrical connector shell as claimed in claim 1, wherein the stop mechanism comprises two spaced stop members disposed on the bottom surface of the shell.

5. The electrical connector shell as claimed in claim 1, wherein the stop mechanism comprises two spaced stop members disposed on the sidewalls of the shell.

6. The electrical connector shell as claimed in claim 1, wherein the stop mechanism comprises two stop members each disposed on a joining portion of the sidewall and the top surface.

7. The electrical connector shell as claimed in claim 1, wherein the stop mechanism comprises two stop members each disposed on a joining portion of the sidewall and the bottom surface.

8. The electrical connector shell as claimed in claim 1, wherein the stop mechanism comprises a plurality of stop members disposed on the top surface and the sidewalls.

9. The electrical connector shell as claimed in claim 1, wherein the stop mechanism comprises a plurality of stop members disposed on the bottom surface and the sidewalls.

10. The electrical connector shell as claimed in claim 1, wherein the stop mechanism comprises a plurality of stop members disposed on the top surface, the bottom surface, and the sidewalls.
